(19) United States
(12) Patent Application Publication
(10) Pub. No.: US 2020/0154720 A1
(43) Pub. Date: May 21, 2020

(54) Dough Substitute for Use in Baking, and Process for Using Substitute

(71) Applicant: Carmen Lindsay, Campbell, CA (US)

(72) Inventor: Carmen Lindsay, Campbell, CA (US)

(21) Appl. No.: 16/195,636

(22) Filed: Nov. 19, 2018

(51) Int. Cl. A21D 13/043; A21D 2/36; A21D 2/16; A21D 8/00; A21D 10/00; A21D 2/26

(52) U.S. Cl. CPC A21D 13/043; A21D 2/36; A21D 2/263; A21D 8/00; A21D 10/007; A21D 2/165

(57) ABSTRACT

In an embodiment, a process for producing a dough-substitute baking compound, comprises mixing, in a single vessel, a combination of almond flour, tapioca flour, coconut flour, garlic, and salt, thereby creating a dry combination. Mozzarella cheese is added to the dry combination to create a semi-dry mixture, and hot cooked cauliflower is mixed in to form a slurry. Olive oil, almond milk, salt, and garlic, are then added in to create a final dough, which is shaped and baked.

### BACKGROUND

The disclosed embodiments relate generally to dough substitutes for use in baking, and processes for making and using the substitute. More specifically, the present invention relates to doughs with a reduced amount of processed carbohydrates and other unwholesome ingredients.

Doughs are typically a mixture of flour or other ground grain seeds mixed with a liquid such as milk or water, and often with yeast and salt. Unfortunately, commercial doughs typically also include chemicals intended to save money during production, increase palatability, and extend the shelf life of the dough, whether cooked or uncooked. These chemicals fall into the category of dough conditioners, preservatives (e.g., calcium propionate which has been linked to ADHD), GMOs, artificial and non-naturally occurring sweeteners (e.g., high fructose corn syrup, which has been implicated in diabetes and obesity), and artificial flavors and coloring (e.g. synthetic dyes and heated ammonia, which have been linked to hyperactivity in children and cancer).

Additionally, commercial dough manufacturers have shown a preference for unbleached flour, which can be bleached with a variety of chemicals such as benzoyl peroxide, calcium peroxide, chlorine dioxide, potassium bromate, dextrose, cornstarch, mono- and di-glycerides, fungal amylase, and others. In addition, such commercial dough can also include ingredients that may seem more natural, such as high-fructose corn syrup, but have been implicated in serious health issues. Such chemicals are so unhealthful that they are banned in many jurisdictions, and have been implicated in a variety of diseases such as cancer, asthma, diabetes, and others.

Because of the amount of whole grains found in some commercial breads, they can be promoted as “healthy,” “100% whole grain,” “a great source of fiber,” and “heart healthy.” These ingredients, however, do not replace most of the “bad” ingredients, and do little to add to the already barely existent nutritional value of the dough.

Products exist that attempt to alleviate some of these health concerns over ingredients, but many of the products that attempt to address the aforementioned concerns are not practical from a palatability standpoint, or not practical, from a usability standpoint. Thus, a need exists for products that have the palatable and usable properties of traditional dough, but that do not require the need for unwholesome chemicals.

### SUMMARY

Embodiments of the present invention describe a dough-substitute baking compound, and the processes for making and using the compound. In an embodiment, a process for producing the dough-substitute baking compound comprises mixing almond flour, tapioca flour, coconut flour, and salt, creating a dry combination. Mozzarella cheese is added to the dry combination, thereby creating a semi-dry mixture. Hot cooked cauliflower is then added to the semi-dry mixture, and mixed to form a slurry. Olive oil and almond milk are added and mixed in, creating a final dough that is then shaped for storage or baking.

### BRIEF DESCRIPTION OF THE DRAWINGS

Embodiments of the present invention are illustrated by way of example, and not by way of limitation, in the figures of the accompanying drawings, in which:

FIG. 1 is a block diagram of a process for creating dough, according to an embodiment of the invention.

TABLE 1 is table of ingredients and quantities for each ingredient, according to an embodiment of the invention.

### DETAILED DESCRIPTION

One or more of the systems and methods described herein describe a way of making and using a dough-substitute baking compound. As used in this specification, the singular forms “a,” “an,” and “the” include plural referents unless the context clearly dictates otherwise.

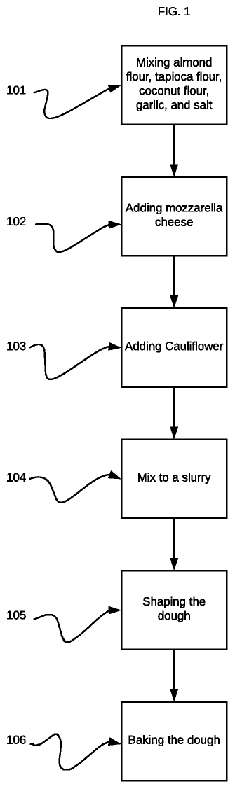

FIG. 1 is a block diagram illustrating an embodiment of a process for creating dough. At 101, dry ingredients are mixed together in a single container to form a dry combination. In an embodiment, dry ingredients include a combination of almond flour, tapioca flour, coconut flour, garlic, and salt. In an embodiment, some of the ingredients are included in the dry combination, while others are added in later. The dry combination can include any kind of commercially available almond flour, tapioca flour, and coconut flour, or any proprietary form of such ingredients. In an embodiment, the salt and garlic can be set aside for later in the process.

In an embodiment, the salt can be table salt, sea salt, kosher salt, flake salt, or any fora of salt. In an embodiment, the garlic can be chopped, powdered, shaved, diced, crushed, or any other common form of garlic that is appropriate for inclusion into dough.

At 102, mozzarella cheese is added to the dry combination to create a semi-dry mixture. The mozzarella cheese is included to provide a combination of taste and texture, especially when melted. In an embodiment, the mozzarella cheese comprises whole-Milk mozzarella cheese. In an embodiment, the mozzarella cheese comprises part-skim mozzarella. In an embodiment, the mozzarella cheese comprises buffalo mozzarella.

Once the mozzarella cheese is added to the dry combination at 102, the combination of dry ingredients and mozzarella cheese creates a semi-dry mixture. At 103, cauliflower is added to the semi-dry mixture. In an embodiment, the cauliflower is uncooked. In another embodiment, the cauliflower is cooked. In an embodiment, the cauliflower, when added, is hot, which is to say, at a temperature sufficient to melt the mozzarella cheese, at least partially, in the semi-dry mixture. When the hot cauliflower is added to and mixed into the semi-dry mixture, in an embodiment, the mozzarella cheese at least partially melts, forming a slurry, at 104. The cauliflower can, in an embodiment, be grated or chopped prior to being cooked; in another embodiment, the cauliflower can be grated or chopped subsequent to being cooked. In an embodiment, the cauliflower can be cauliflower rice, or a combination of cauliflower rice, grated cauliflower, and chopped cauliflower.

If any of the dry ingredients have not been added, they can be added at any time after the mozzarella cheese is added. In an embodiment, the salt and garlic are added after the cauliflower is mixed in, and the quantity is controlled to provide a preferred taste.

Once all the ingredients are added and mixed into a slurry, the slurry can be removed from whatever container it was formed in, and shaped into a dough, at 105. In an embodiment, the dough is shaped into a substantially spherical mass. Once the dough is in a spherical mass, it is then flattened by hand, rolling pin, or otherwise, to a desired thickness, and baked, at 106.

Once the dough is ready for baking, it can be fully or partially baked as a standalone product. Alternatively, the dough can be fully or partially baked as part of a different product In one embodiment, the dough is flattened and topped with tomato sauce, mozzarella cheese, and possibly other toppings such as parmesan cheese, oregano, mushrooms, pepperoni, or other pizza-related toppings, and baked as a single product to form a pizza. In another embodiment, the dough may be fully baked and then either consumed or sold as a standalone product, ready for receiving toppings, or to be used as a bread substitute for sandwiches. In another embodiment, the dough may be partially baked such that it can be sold or stored in the partially baked state. The baking can be completed after toppings are added.

In an embodiment, the dough is cooked at 450 degrees Fahrenheit for 6 minutes. In an embodiment, the dough is cooked at a higher temperature for 6 minutes, or at the same or lower temperature for a longer period of time, to create a crusty, tortilla-like product.

In an embodiment, a dry combination of the dough's ingredients is used to dust a baking surface such as a silicone baking mat, a baking sheet, a baking stone, a non-stick or Teflon baking surface, or any other surface suitable for holding the dough while it bakes. In practice, the baking vessel, which can be a sheet, a pan, a dish, or any type of practicable baking vessel is chosen based on the desired result after baking. For example, if a pizza-shaped dough is required, a sheet, mat, or other flat surface will typically be used. If a loaf is desired, then a baking pan or baking dish would typically be chosen.

Table 1 lists the percent by weight of each ingredient of the dough, according to an embodiment of the present invention. Column 1 of Table 1 displays ingredients included in the dough, an embodiment, according to an embodiment. Column 2 of Table 1 displays the percentage by weight of each of the ingredients. In an embodiment, the ingredients include a combination of almond flour, tapioca flour, coconut flour, cauliflower, mozzarella cheese, almond milk, olive oil, salt, and garlic. As can be seen in Column 2, according to an embodiment, the dough comprises the ingredients found in Column 1 in the following percentages by weight: almond flour is 12.9% by weight; tapioca flour is 18.2% by weight; coconut flour is 1.9% by weight; cauliflower is 35.2% by weight; mozzarella cheese is 15.7% by weight; almond milk is 8.5% by weight, olive oil is 6.6% by weight; salt is 0.8% by weight, and garlic is 0.3% by weight.

One skilled in the art will understand that one may alter some combination of the taste, texture, or cooking time of the dough by altering the percentage by weight of each ingredient. Such alteration can be acceptable in the final product (for example, if using the final product as pizza dough) if the alteration of each ingredient is kept within a certain range. Column 3 of Table 1 displays a range of the percentage of ingredients by weight whereby the percentage of weight may be varied while still retaining the characteristics of dough. In Column 3, we see that the range of Almond Flour can be varied from 5% by weight to 25% by weight; the Tapioca Flour can be varied from 8% by weight to 28% by weight; the Coconut Flour can be varied from 0.4% by weight to 6.5% by weight; the Cauliflower can be varied from 15% by weight to 60% by weight; the Mozzarella Cheese can be varied from 5% by weight to 30% by weight; the Almond Milk can be varied from 4% by weight to 17% by weight; the Olive Oil can be varied from 2% by weight to 17% by weight; the Salt can be varied from 0% by weight to 2.8% by weight; and the Garlic can be varied from 0% by weight to 1.5% by weight.

Once the dough is prepared and shaped, it can be used as a basis for different products. In an embodiment, the dough can be shaped into a substantially flat shape appropriate for a pizza dough that can be topped with a combination of mozzarella cheese, oregano, parmesan cheese, and tomato sauce. In an embodiment, the dough can be topped with ricotta cheese along with mozzarella cheese to create a white pizza.

In an embodiment, the dough is cut into pieces and baked until crisp, forming, for example, tortilla chips. In an embodiment, the dough can be shaped into a shape appropriate for creating a loaf that can be sliced.

One skilled in the art will understand, in the context of embodiments of the invention, that the term “a combination of” includes zero, one, or more, of each item in the list of items to be combined.

While certain embodiments have been shown and described above, various changes in form and details may be made. For example, some features of embodiments that have been described in relation to a particular embodiment or process can be useful in other embodiments. Some embodiments that have been described in relation to a software implementation can be implemented as digital or analog hardware. Furthermore, it should be understood that the systems and methods described herein can include various combinations and/or sub-combinations of the components and/or features of the different embodiments described. For example, types of verified information described in relation to certain services can be applicable in other contexts. Thus, features described with reference to one or more embodiments can be combined with other embodiments described herein.

Although specific advantages have been enumerated above, various embodiments may include some, none, or all of the enumerated advantages. Other technical advantages may become readily apparent to one of ordinary skill in the art after review of the figures and description.

It should be understood at the outset that, although exemplary embodiments are illustrated in the figures and described above, the present disclosure should in no way be limited to the exemplary implementations and techniques illustrated in the drawings and described herein.

Modifications, additions, or omissions may be made to the systems, apparatuses, and methods described herein without departing from the scope of the disclosure. For example, the manufacture of the products disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

TABLE 1

| Column 1 | Column 2 | Column 3 |
|---|---|---|
| Ingredient | Ingredient % By Weight | Range |
| Almond Flour | 12.9% | 5-25% |
| Tapioca Flour | 18.2% | 8-28% |
| Coconut Flour | 1.9% | 0.4-6.5% |
| Cauliflower | 35.2% | 15-60% |
| Mozzarella Cheese | 15.7% | 5-30% |
| Almond Milk | 8.5% | 4-17% |
| Olive Oil | 6.6% | 2-17% |
| Salt | .8% | 0-2.8% |
| Garlic | .3% | 0-1.5% |

I claim:

1. A process for producing a dough-substitute baking compound, comprising:
mixing, in a single vessel, almond flour, tapioca flour, coconut flour, garlic, and salt, creating a dry combination;
adding mozzarella cheese to the dry combination to create a semi-dry mixture;
adding hot cooked cauliflower to the semi-dry mixture;
mixing the hot cooked cauliflower into the semi-dry mixture to form a slurry;
mixing into said slurry olive oil, almond milk, salt, and garlic, to create a final dough;
shaping the final dough;
baking the final dough.

2. The method of claim 1, wherein the cauliflower is cauliflower rice.

3. The method of claim 2, wherein said shaping the final dough includes:
forming the dough into a substantially spherical mass; and
pressing the substantially spherical mass into a substantially flat shape.

4. The method of claim 2, further comprising:
after forming the slurry, letting stand for approximately one minute; and
stirring the slurry for 15 seconds with a substantially flat tool.

5. The process of claim 3, wherein said baking the final dough includes:
preheating an oven to approximately 450 degrees;
placing the dough into the preheated oven for approximately 6 minutes.

6. The method of claim 2, further comprising:
creating a second amount of the dry combination;
dusting a baking surface with the second amount of the dry combination; and
pressing the final dough into a substantially flat shape before baking.

7. The method of claim 3, wherein:
the cauliflower rice comprises approximately 35.2% by weight of the final dough;
the almond flour comprises approximately 12.9% by weight of the final dough;
the tapioca flour comprises 18.2% by weight of the final dough;
the coconut flour comprises approximately 1.9% by weight of the final dough;
the mozzarella cheese comprises approximately 15.7% by weight of the final dough;
the almond milk comprises approximately 8.5% by weight of the final dough;
the olive oil comprises approximately 6.6% by weight of the final dough;
the salt comprises approximately 0.8% by weight of the final dough; and
the garlic comprises approximately 0.3% by weight of the final dough.

8. The method of claim 5, wherein:
the cauliflower rice comprises approximately 35.2% by weight of the final dough;
the almond flour comprises approximately 12.9% by weight of the final dough;
the tapioca flour comprises 18.2% by weight of the final dough;
the coconut flour comprises approximately 1.9% by weight of the final dough;
the mozzarella cheese comprises approximately 15.7% by weight of the final dough;
the almond milk comprises approximately 8.5% by weight of the final dough;
the olive oil comprises approximately 6.6% by weight of the final dough;
the salt comprises approximately 0.8% by weight of the final dough; and
the garlic comprises approximately 0.3% by weight of the final dough.

9. The method of claim 1, wherein final dough is fully baked.

10. The method of claim 1, wherein the final dough is partially baked.

11. A dough-substitute baking compound, comprising almond flour, tapioca flour, coconut flour, cauliflower, mozzarella cheese, almond milk, olive oil, and salt.

12. The dough-substitute baking compound of claim 11, further comprising garlic.

13. A dough-substitute baking compound prepared by a process comprising the steps of:
mixing, in a single vessel, almond flour, tapioca flour, and coconut flour, creating a dry combination;
adding mozzarella cheese to the dry combination to create a semi-dry mixture;
adding hot cooked cauliflower to the semi-dry mixture;
mixing the hot cooked cauliflower into the semi-dry mixture to form a slurry;
mixing into said slurry a quantity of olive oil, almond milk, salt, and garlic, to create a final dough;
shaping the final dough;
baking the final dough.

14. The dough-substitute baking compound prepared by the process of claim 13, further including adding at least one of salt and garlic.
